(19) United States
(12) Patent Application Publication
(10) Pub. No.: US 2009/0267266 A1
(43) Pub. Date: Oct. 29, 2009

(54) INSERT-MOLDED COVER AND METHOD FOR MANUFACTURING SAME

(75) Inventors: HAN-MING LEE, Tu-Cheng (TW); CHIH-CHIEN HUNG, Tu-Cheng (TW); HSIANG-SHENG CHOU, Tu-Cheng (TW); CHING-HSIEN CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/187,396

(22) Filed: Aug. 7, 2008

(30) Foreign Application Priority Data
Apr. 28, 2008 (CN) 200810301382.6

(51) Int. Cl. B29C 45/14; H01Q 13/00

(52) U.S. Cl. 264/272.11; 29/600

(57) ABSTRACT

The present invention relates to an insert-molded cover (10) for a electronic device. The insert-molded cover includes a metallic body (11) and a plastic antenna lid (12) integrally formed on an edge of the metallic body. An outer surface (101) of a junction of the metallic body and the plastic antenna lid is smooth and painted by a coating (13). The present invention also relates a method for manufacturing an insert-molded cover for electronic devices.

### CROSS-REFERENCE TO RELATED APPLICATIONS

This application is related to five co-pending U.S. patent applications, applications Ser. No. 12/171271, Ser. No. [to be advised] (Docket No. US20076), Ser. No. [to be advised] (Docket No. US20421), Ser. No. [to be advised] (Docket No. US20075), and all entitled “INSERT-MOLDED COVER AND METHOD FOR MANUFACTURING SAME”; applications Ser. No. [to be advised] (Docket No. US20071), entitled “JOINING STRUCTURE AND INSERT-MOLDED COVER USING SAME”. In the co-pending applications, the inventors are Han-Ming Lee, Chih-Chien Hung, Hsiang-Sheng Chou and Ching-Hsien Chang. Such applications have the same assignee as the present application and have been concurrently filed herewith. The disclosures of the above identified applications are incorporated herein by reference.

### BACKGROUND OF THE INVENTION

1. Field of the Invention

The present invention relates to insert-molded covers and, more particularly, to an insert-molded cover used for a electronic device and a method for manufacturing the insert-molded cover.

2. Discussion of the Related Art

Electronic devices, such as notebook computers, mobile phones, or personal digital assistants (PDAs), are very popular and widely used. Covers of electronic devices are generally made of two kinds of materials, plastic and metal. Generally, a metallic cover has a nicer appearance and a better surface feeling than a plastic one, thus metallic covers for electronic devices are now becoming more and more popular.

Because the metal has a good electromagnetic shielding capability, a portion of the cover corresponding to an antenna of an electronic device is made of plastic, so that signals can be received and transmitted through the plastic portion, and certain functions would not be weaken by electromagnetic shielding. Generally, the metallic cover includes a metallic body and a plastic antenna lid fixed to the metallic body by hook locking or rivet jointing. However, these fixing means easily leave a gap between the plastic antenna lid and the metallic body, such that an appearance of the metallic cover would have an inaesthetic appearance, and furthermore, the plastic antenna lid easily becomes loosened from the metallic body due to the gap. In addition, a thin metallic cover is susceptible to crack at the junction where the plastic antenna lid is fixed to the metallic body by hook locking or rivet jointing. Therefore, the mechanical strength and durability of the metallic cover is relatively compromised.

What is needed, therefore, is a new insert-molded cover that overcomes the above mentioned disadvantages.

### SUMMARY

In one aspect, an insert-molded cover for electronic devices includes a metallic body and a plastic antenna lid integrally formed on the edge of the metallic body. An outer surface of a junction of the metallic body and the plastic antenna lid is smooth and painted by a coating.

In another aspect, a method for manufacturing an insert-molded cover for electronic devices includes following steps. Firstly, a metallic body is manufactured. Secondly, a plastic antenna lid is molded on the metallic body by insert molding, and an outer surface of a junction of the metallic body and the plastic antenna lid is a smooth surface. Thirdly, the insert-molded cover is painted to form a coating on the outer surface of the junction of the metallic body and the plastic antenna lid.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present insert-molded cover for electronic devices. Moreover, in the drawings, like reference numerals designate corresponding parts throughout the several views.

FIG. 1 is an exploded, isometric view of an insert-molded cover of the present invention in accordance with one preferred embodiment.

FIG. 2 is a unitary, topisometric view of the insert-molded cover in FIG. 1.

FIG. 3 is a partially cross-sectional isometric view of the insert-molded cover in FIG. 2.

FIG. 4 is a unitary, bottom isometric view of the insert-molded cover in FIG. 2.

FIG. 5 is a partially, enlarged view of an insert-molded cover of FIG. 4, but viewed from a different aspect.

FIG. 6 is a partially, side cross-sectional view of the insert-molded cover in FIG. 5, taken along the line VI-VI thereof.

FIG. 7 is a partially, side cross-sectional view of the insert-molded cover in FIG. 5, taken along the line VII-VII thereof.

FIG. 8 is a partially, side cross-sectional view of the insert-molded cover in FIG. 5, taken along the line VIII-VIII thereof.

FIG. 9 is a partially, side cross-sectional view of the insert-molded cover in FIG. 5, taken along the line IX-IX thereof.

### DETAILED DESCRIPTION OF THE EMBODIMENTS

Reference will now be made to the drawings to describe preferred embodiments of the present insert-molded cover, in detail. The insert-molded cover is used for electronic devices such as notebook computers, and mobile phones.

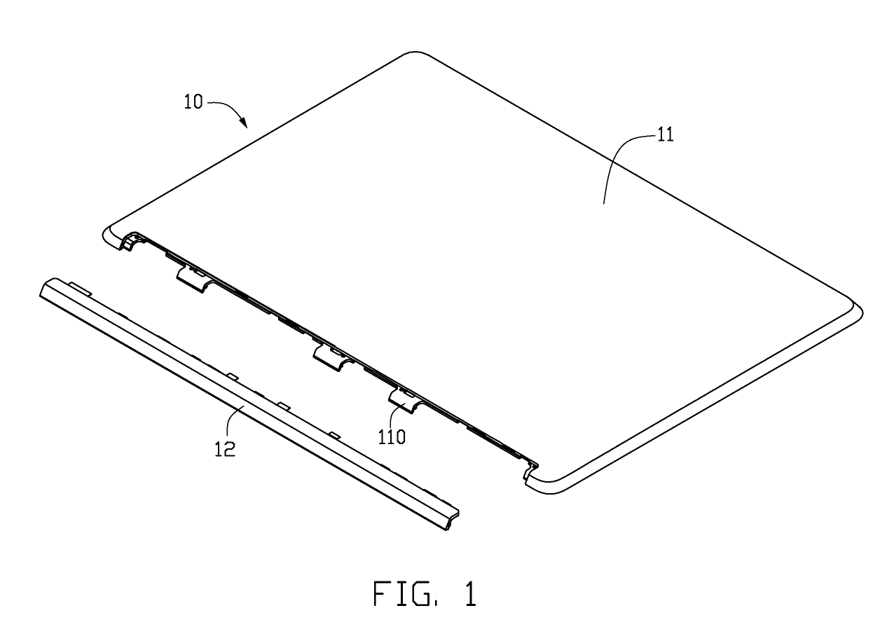

Referring to FIG. 1, an insert-molded cover 10 for electronic devices according to a preferred embodiment is shown. The insert-molded cover 10 includes a metallic body 11 and a plastic antenna lid 12.

The metallic body 11 is substantially a rectangular plate made of alloy, and the alloy is preferably magnesium alloy, aluminum alloy or titanium alloy. A plurality of latching portions 110 are formed on an edge of the metallic body 11, for latching the plastic antenna lid 12 in a molding process.

The plastic antenna lid 12 is substantially an elongated plate. The plastic antenna lid 12 is configured to be formed on the edge of the metallic body 11 adjoining the plurality of latching portions 110. Material of the plastic antenna lid 12 should have a good bonding ability with material of the metallic body 11. In other words, the material of the plastic antenna lid 12 should have a low shrinkage and a similar linear expansion with the material of the metallic body 11. Thus, the material of the plastic antenna lid 12 is selected from the group consisting of liquid crystal polymer(LCP), polyphenylene sulphide(PPS), polybutylene terephthalate(PBT) and their combination.

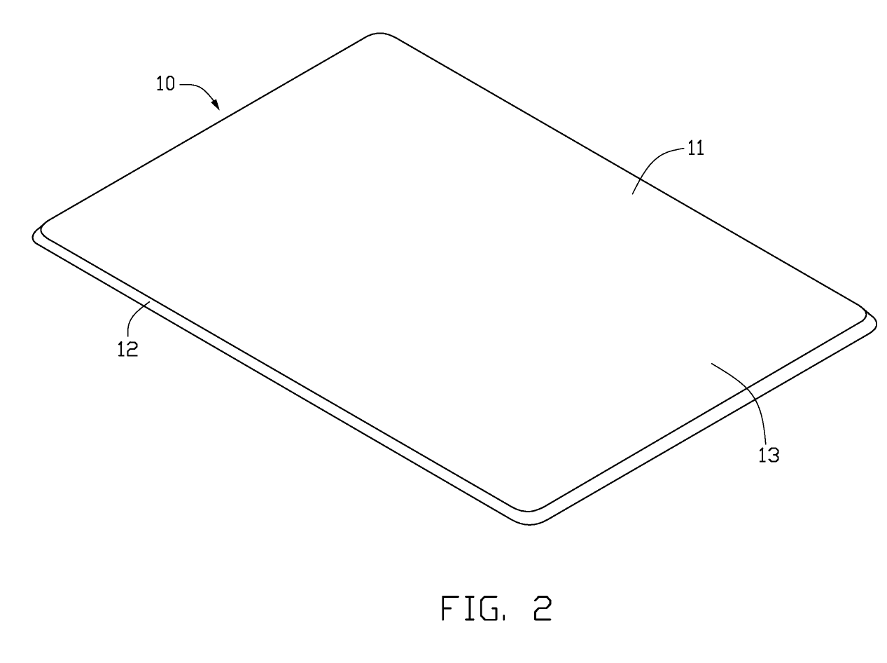

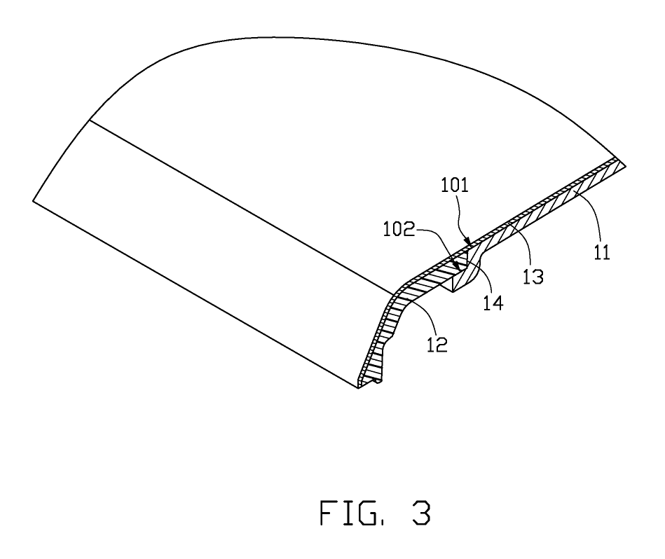

Referring to FIGS. 2 and 3, the metallic body 11 and the plastic antenna lid 12 are firmly joined together. An outer surface 101 of a junction of the metallic body 11 and the plastic antenna lid 12 is smooth and painted by a coating 13, thus, there is no joint formed on the insert-molded cover 10 and the insert-molded cover 10 would have a good appearance. In addition, a joined surface 102 of the metallic body 11 and the plastic antenna lid 12 is a step surface for increasing the joined area of them, so that the bonding strength of the metallic body 11 and the plastic antenna lid 12 is enhanced.

The thickness of the coating 13 can be in a range from about 30 microns to about 90 microns. The coating 13 is made of materials including film forming matters, pigments, solvent agents, and additive agents. The film forming matters mainly include a colophony selected from the group consisting of polyethylene (PE), polypropylene (PP), polyvinyl chloride (PVC), polystyrene (PS), polyurethane (PU), urea formaldehyde (UF), phenol formaldehyde resin (PF), ethylene resin (ER), acrylonitrile-butadiene-styrene (ABS), polymethyl methacrylate (PMMA), polycarbonate (PC), polytetyafluoroethylene (PTFE), polyimide (PI) and their combination. The pigments are selected from titanium dioxide, carbon black, iron oxide red and so on. The solvent agents are organic solvent agents, such as ethanol, acetone, benzene group and so on. The additive agents can be a foaming agent, a lubricant, a stabilizer or a flame retardant for improving characters of the coating 13, such as its density, weight, rigid, chemical resistance, or heat resistance.

A method for manufacturing the insert-molded cover 10 includes following steps.

Firstly, a metallic body 11 is manufactured by casting, forging, or extrusion molding methods.

Secondly, a plastic antenna lid 12 is molded on the metallic body 11 by insert molding. At the same time, an out surface 101 of a junction of the metallic body 11 and the plastic antenna lid 12 is formed as a smooth surface. In detail, the metallic body 11, as an insert member, is placed into an injection mold, then melted plastic is injected into the injection mold. After the melted plastic is cooled, the plastic antenna lid 12 is achieved. Thus, the insert-molded cover 10 is integrally formed.

Thirdly, the insert-molded cover 10 is painted to form a coating 13 on the outer surface 101 of the junction of the metallic body 11 and the plastic antenna lid 12. In detail, the insert-molded cover 10 is cleaned to remove dusts, oxides or greasy dirt, and the insert-molded cover 10 is pretreated by a chemical method, thus, an undercoating is formed on a surface of the insert-molded cover 10. Then the insert-molded cover 10 is painted by bake painting or spray painting methods, such that the coating 13 is formed on the outer surface 101 of the insert-molded cover 10.

It should be pointed out that, after the first step, the metallic body 11 can be polished and processed by a chemical method, such as micro-arc oxidation method or anode oxidation method, thus an oxidation layer is formed on a surface of the metallic body 11. The oxidation layer is configured to improve the bonding strength of the metallic body 11 and the plastic antenna lid 12.

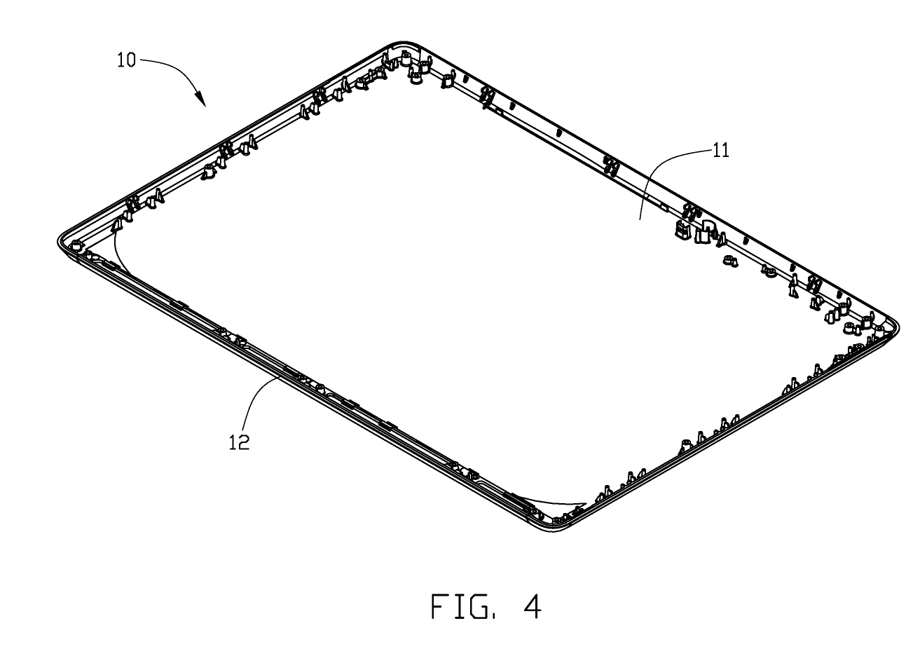

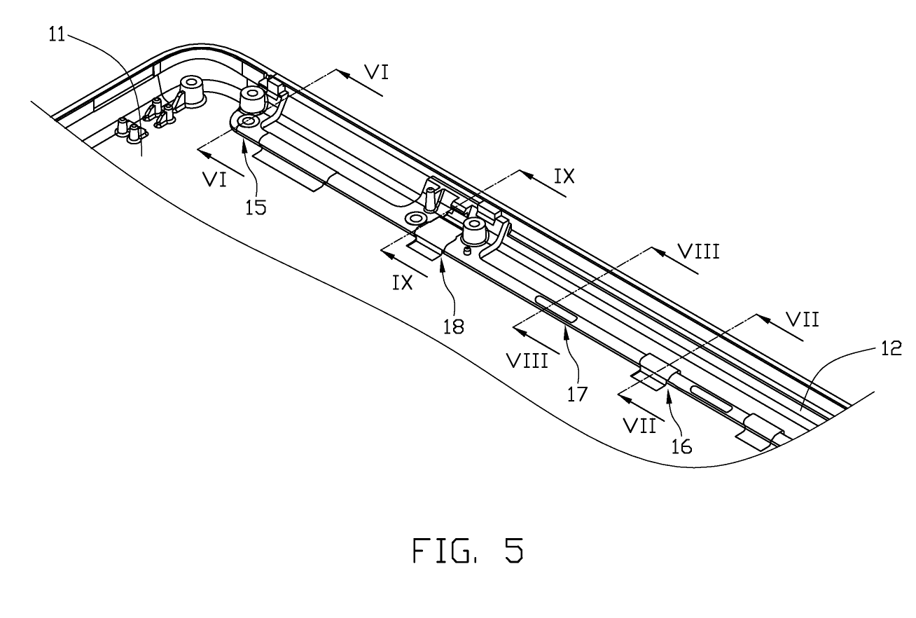

Referring to FIGS. 4 and 5, the insert-molded cover 10 includes a first latching structure 15, a second latching structure 16, a third latching structure 17, and a fourth latching structure 18 formed on a boundary of the metallic body 11 and the plastic antenna lid 12 for improving the bonding strength of between them further more.

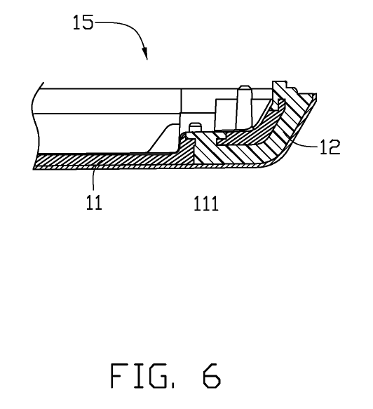

Referring to FIGS. 5 and 6, the first latching structure 15 is formed by following means. After the first step, a stepped hole 111 is formed in a side portion of the metallic body 11 via a computerized numerical control (CNC) equipment. An end of the stepped hole 111 adjacent to an inner surface of the metallic body 11 has a larger aperture than another end of the stepped hole 111 adjacent to an outer surface of the metallic body 11. In the molding process of the plastic antenna lid 12, the melted plastic flows into the stepped hole 111 until the stepped hole 111 is filled with melted plastic. After the melted plastic is cooled, the first latching structure 15 is formed on the boundary of the metallic body 11 and the plastic antenna lid 12.

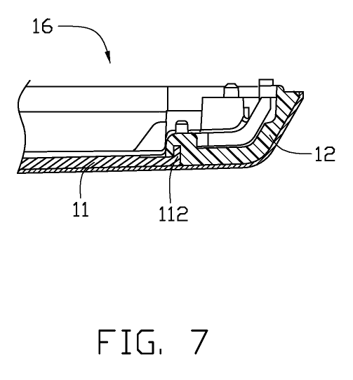

Referring to FIGS. 5 and 7, the second latching structure 16 is formed by following means. After the first step, a hook 112 is formed in a side portion of the metallic body 11 via the CNC equipment. In the molding process of the plastic antenna lid 12, the hook 112 is enveloped by the melted plastic. After the melted plastic is cooled, the second latching structure 16 is formed on the boundary of the metallic body 11 and the plastic antenna lid 12.

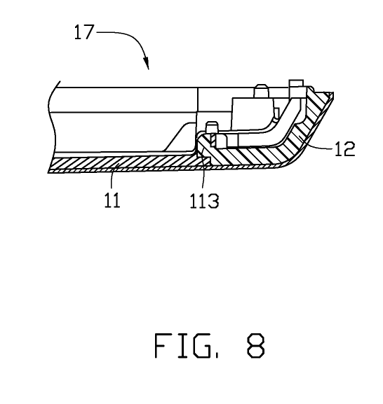

Referring to FIGS. 5 and 8, the third latching structure 17 is formed by following means. After the first step, a through hole 113 is formed in a side portion of the metallic body 11 via the CNC equipment. In the molding process of the plastic antenna lid 12, the melted plastic flows into the through hole 113 until the through hole 113 is filled with melted plastic. After the melted plastic is cooled, the third latching structure 17 is formed on the boundary of the metallic body 11 and the plastic antenna lid 12.

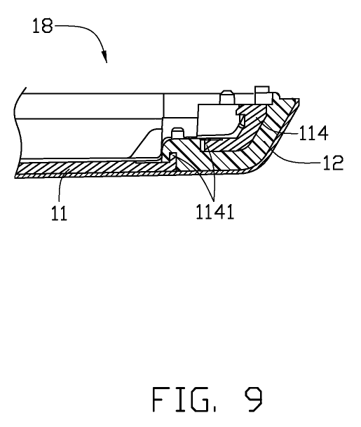

Referring to FIGS. 5 and 9, the fourth latching structure 18 is formed by following means. After the first step, a convex stage 114 is formed on a side portion of the metallic body 11 via the CNC equipment, the convex stage 114 has two hooks 1141. In the molding process of the plastic antenna lid 12, an outer surface of the convex stage 114 and the two hooks 1141 are enveloped by the melted plastic. After the melted plastic is cooled, the fourth latching structure 18 is formed on the boundary of the metallic body 11 and the plastic antenna lid 12.

In an alternative embodiment, the stepped hole 111, the hook 112, the through hole 113 and the convex stage 114 are integrally formed with the metallic body 11 by casting.

It should be pointed that, the latching portion 110 may be replaced by other latching portions, except the stepped hole 111, the hook 112, the through hole 113 or the convex stage 114. The latching structure formed on the boundary of the metallic body 11 and the plastic antenna lid 12 can be selected from the group of the first latching structure 15, the second latching structure 16, the third latching structure 17, the fourth latching structure 18, or their combination.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An insert-molded cover, used for electronic devices, the insert-molded cover comprising:
a metallic body; and
a plastic antenna lid integrally formed with the metallic body;
wherein an outer surface of a junction of the metallic body and the plastic antenna lid is smooth and painted by a coating.

2. The insert-molded cover as claimed in claim 1, wherein a joined surface of the metallic body and the plastic antenna lid is a step surface.

3. The insert-molded cover as claimed in claim 2, wherein the thickness of the coating is in a range from about 30 microns to about 90 microns.

4. The insert-molded cover as claimed in claim 3, wherein the coating is made of materials comprises film forming matters, pigments, solvent agents, and additive agents.

5. The insert-molded cover as claimed in claim 4, wherein the film forming matters mainly comprises a colophony selected from the group consisting of polyethylene, polypropylene, polyvinyl chloride, polystyrene, polyurethane, urea formaldehyde, phenol formaldehyde resin, ethylene resin, acrylonitrile-butadiene-styrene, polymethyl methacrylate, polycarbonate, polytetyafluoroethylene, polyimide and their combination.

6. The insert-molded cover as claimed in claim 1, wherein the metallic body is a rectangular plate made of magnesium alloy.

7. The insert-molded cover as claimed in claim 1, wherein the metallic body comprises at least one latching portion formed on an edge of the metallic body, and the at least one latching portion latches with the plastic antenna lid and forms at least one latching structure.

8. The insert-molded cover as claimed in claim 7, wherein each of the at least one latching portion is selected from the group consisting of a stepped hole, a hook, a through hole, a convex stage and their combination.

9. The insert-molded cover as claimed in claim 1, wherein the plastic antenna lid is made of a material selected from the group consisting of liquid crystal polymer, polyphenylene sulphide, polybutylene terephthalate and their combination.

10. A method for manufacturing an insert-molded cover for electronic devices, comprising:
manufacturing a metallic body;
molding a plastic antenna lid on the metallic body by insert molding, and an outer surface of a junction of the metallic body and the plastic antenna lid being a smooth surface; and
painting the insert-molded cover to form a coating on the outer surface of a junction of the metallic body and the plastic antenna lid.

11. The method for manufacturing an insert-molded cover as claimed in claim 10, wherein the metallic body is manufactured by casting, forging, or extrusion molding methods.

12. The method for manufacturing an insert-molded cover as claimed in claim 10, wherein before painting the insert-molded cover, the insert-molded cover is cleaned and pretreated by a chemical method, thus a primer is formed on a surface of the insert-molded cover.

13. The method for manufacturing an insert-molded cover as claimed in claim 10, wherein the metallic body comprises at least one latching portion formed on an edge of the metallic body, and the at least one latching portion latches with the plastic antenna lid and forms at least one latching structure.

14. The method for manufacturing an insert-molded cover as claimed in claim 13, wherein the at least one latching portion is a stepped hole, when molding the plastic antenna lid, the melted plastic flows into the stepped hole until the stepped hole is filled with melted plastic, after the melted plastic is cooled, a first latching structure is formed on the boundary of the metallic body and the plastic antenna lid.

15. The method for manufacturing an insert-molded cover as claimed in claim 13, wherein the at least one latching portion is a hook, when molding the plastic antenna lid, the hook is enveloped by the melted plastic, after the melted plastic is cooled, a second latching structure is formed on the boundary of the metallic body and the plastic antenna lid.

16. The method for manufacturing an insert-molded cover as claimed in claim 13, wherein the at least one latching portion is a through hole, when molding the plastic antenna lid, the melted plastic flows into the through hole until the through hole is filled with melted plastic, after the melted plastic is cooled, a third latching structure is formed on the boundary of the metallic body and the plastic antenna lid.

17. The method for manufacturing an insert-molded cover as claimed in claim 13, wherein the at least one latching portion is a convex stage, the convex stage has two hooks, when molding the plastic antenna lid, an outer surface of the convex stage and the two hooks are enveloped by the melted plastic, after the melted plastic is cooled, a fourth latching structure is formed on the boundary of the metallic body and the plastic antenna lid.
